(19) United States
(12) Patent Application Publication
(10) Pub. No.: US 2011/0066506 A1
(43) Pub. Date: Mar. 17, 2011

(54) SOCIAL NETWORKING MONETIZATION SYSTEM AND METHOD

(75) Inventors: Kai-Min E. Sung, Foster City, CA (US); Frederick W. Hsu, Seattle, WA (US); Joyce C. Hsu, Seattle, WA (US)

(73) Assignee: Social App Holdings, LLC, Seattle, WA (US)

(21) Appl. No.: 12/879,873

(22) Filed: Sep. 10, 2010

Related U.S. Application Data
(60) Provisional application No. 61/241,798, filed on Sep. 11, 2009.

(51) Int. Cl. G06Q 30/00

(52) U.S. Cl. 705/14.66; 705/14.69

(57) ABSTRACT

A monetization system to share in the revenue generated from advertisements associated with a social application generated by a user of a social network service. When another user of the social network service requests to access the social application, the monetization system responds to the request with an instance of the application that includes one or more advertisements. The monetization system determines an amount payable to the creator of the application based on the display of the advertisements and/or any actions taken with respect to a displayed advertisement.

### CROSS-REFERENCE TO RELATED APPLICATIONS

This application claims the benefit of U.S. Provisional Application No. 61/241,798 entitled “SHARED MONETIZATION OF USER-GENERATED APPLICATIONS” of F. Hsu et al., filed Sep. 11, 2009, the entirety of which is incorporated by reference herein.

### BACKGROUND

The growth and popularity of social networking websites has changed the way people engage and interact with others. Social networking websites allow users to create and modify web pages containing personal details about themselves, search for other users (e.g., friends, colleagues, family, organizations, etc.), create and/or join groups according to their interests, share pictures, exchange public or private messages, and so on. Some social networking websites provide application programming interfaces (“APIs”) that allow technology savvy users to develop and distribute “social” applications. Social applications typically are applications that increase the communal nature of a social networking website. For example, a user may use a social application to send virtual gifts to other users, to post classified advertisements, to inform others about upcoming events for an organization, to share videos, and so on. To develop a social application, a user must be well versed in programming languages such as PHP, Ruby on Rails, JavaScript, or the like. Likewise, the user must understand the fundamentals of web hosting and have a place to host their application. Unfortunately, users that do not possess the necessary skill set are unable to develop social applications, and thus are unable to fully participate in their social network community. Moreover, although social networking websites serve as both suppliers and consumers of user-generated content, there is no mechanism by which users are compensated for the content they generate.

### BRIEF DESCRIPTION OF THE DRAWINGS

FIG. 1 is a high-level ecosystem diagram of various entities and computer systems that are part of, or interact with, a monetization system, in one embodiment.

FIGS. 2A-2F are screenshots of an example interface of the application builder, in one embodiment.

FIG. 3 is a screenshot of an example interface of an application dashboard, in one embodiment.

FIGS. 4A-4G are screenshots of example reporting interfaces, in one embodiment.

FIG. 5 is a screenshot of an example payment interface, in one embodiment.

FIG. 6 is a block diagram of various components or services that are part of a monetization server, in one embodiment.

FIG. 7 is a block diagram showing an example architecture of a monetization server, in one embodiment.

FIG. 8 is a flow chart of a social application monetization process, in one embodiment.

FIGS. 9A-9B are screenshots of example interfaces of a monetization system, in one embodiment.

FIG. 10 is a screenshot of an example interface to share and promote a social application, in one embodiment.

FIGS. 11A-11E are screenshots of example interfaces implementing techniques to increase the virility of a social application, in one embodiment.

FIG. 12 is a screenshot of an example interface of a social application contest implemented by the monetization system, in one embodiment.

### DETAILED DESCRIPTION

A monetization system is disclosed that enables a user of a social networking website to be compensated for revenue generated from advertisements associated with content generated by the user (the “creator”), such as a social application. As used herein, the term “social application” refers to an application that allows users of a social network service to interact and/or share user-generated content. For example, a user may create a “name decoder” application (“What's your Hippie Name?”) by constructing their own grammar and/or dictionary that is used to generate funny and creative names (e.g., Eccentric Dazed Dissenter Yoga) from the letters of a user's name (e.g., Eddy). Other examples of social applications include: quiz applications, quote applications, trivia applications, puzzle applications, gifting applications, competitive gaming applications, or the like. When another user (“consumer”) of the social network service requests access to a social application, the monetization system responds to the request with an instance of the application that includes one or more advertisements. The monetization system determines an amount payable to the creator of the application based on the display of the advertisements and/or any actions taken by the consumer with respect to a displayed advertisement.

In some embodiments, the monetization system includes or communicates with an application builder that enables a user of a social networking website to create social applications without requiring the user to have any technical training or software programming knowledge. For example, the application builder may include an interface that enables a user to select from a number of social application templates. In some embodiments, the social application templates are customizable. For example, if a user selects a trivia quiz template, the user may specify the number of questions and/or answers to each trivia question, whether and how the answers are scored, and so on. As another example, if the user selects a competitive game template, the user may specify the number of participants in the competitive game, the number of levels, the color scheme, and so on. In some embodiments, the application builder provides a WYSIWYG (“What You See Is What You Get”) interface. The WYSIWYG interface may include text editing, formatting, spell check, controls to provide links to or embed images, rich media, widgets, etc. The application builder is not limited to text-based user-generated content. For example, user-generated content of a social application may include images, audio, video, RSS feeds, widgets, and/or the like. As such, examples of text-based user-generated content should not be taken as restrictive. The application builder may be accessed by users of a social network service through the social networking website and/or the monetization system.

In some embodiments, the monetization system stores content created by the user and serves it to other users (“consumers”) of the social network service. For example, the monetization system may host a social application, such as a personality quiz, created by a user of a social network for distribution to other users of the social network. The monetization system may store the user-generated content of a social application separately from the social application template. In such embodiments, the monetization system dynamically populates the corresponding social application template with the user-generated content in response to a request to access the social application.

In some embodiments, the monetization system monitors users' access to a social application and detects actions performed by users pertaining to the social application and/or advertisements associated with the social application. The monetization system compiles this information into statistics pertaining to the use of the social application and/or revenue generated by users' access to the social application. For example, the generated statistics may include an indication of the advertising impressions for the social application by date, by gender, by age, by connection, by geographic location, and so on. It will be appreciated by those skilled in the art that the monetization system may monitor users' access to any number of social applications. Similarly, the monetization system may compile combined statistics for all social applications created by the user as well as individual statistics for each application. As such, references to a single application should not be taken as restrictive.

In some embodiments, the monetization system provides an interface that allows advertisers to submit advertisements that are to be displayed with, or on, user-generated social applications. The monetization system may allow advertisers to target users based on demographics, application content, application type, application category, and so on. For example, an advertiser may submit an advertisement and specify that it is only to be displayed with social applications that include one or more keywords (e.g., baby, diaper, etc.) and are accessed by female users between the ages of twenty-five and forty. The monetization system may automatically associate advertisements with a social application based on the parameters specified by the advertiser. In some embodiments, the interface includes a control for an advertiser to associate different rates that the advertiser is willing to pay for a submitted advertisement or campaign. For example, an advertiser may pay a rate of $2 for every thousand advertisements placed on social applications categorized as “fashion” applications and accessed by female users, and a rate of $0.50 for every thousand advertisements placed on any social applications not satisfying the specified parameters. In some embodiments, in response to receiving a request to access a social application, the monetization system identifies multiple advertisements available for display on the requested application and ranks each advertisement. For example, the monetization system may rank the advertisements based on the parameters specified by the advertiser, the revenue potential of the advertisement, the past performance of the advertisement (e.g., the frequency that users accessing the requested social application clicked on the presented advertisement, purchase the advertised product or service, etc.), and/or the like. The monetization system selects one or more of the identified advertisement in accordance with the attributed rankings.

In some embodiments, the monetization system provides an interface that allows a user to indicate whether advertisements may be associated with a social application generated by that user. In some embodiments, a user may identify certain types of advertisements that may be served together with a social application created by the user. Users may expressly include or exclude advertisements by type, category, and/or brand. For example, if a user authors a trivia quiz about dogs, then the user may indicate that only pet care or veterinarian advertisements may be presented with the social application. As another example, if the user creates a social application intended for young children, the user may expressly exclude adult advertisements (e.g., cigarettes, alcohol, pornography, etc). Users may also indicate a preference for certain advertisements by type, category, or brand without expressly including or excluding others. In other embodiments, advertisements are automatically associated with, or placed on, a user-generated social application irrespective of any selection by the user that created the social application.

In some embodiments, the monetization system includes a payment module that calculates the share of advertising revenue owed to a user (“creator”) when another user (“consumer”) of the social networking website accesses a social application generated by the user. As used herein, the phrase “revenue share” or similar phrases are used to refer to an amount payable to a creator of a social application resulting from the presentation of one or more advertisements or actions taken with respect to a presented advertisement. The amount payable to a creator may be calculated for each application individually, for all applications, and/or for a combination of applications. The revenue share may be calculated based on a number of factors, including, for example, the number of impressions and/or actions taken by the consumer. As used herein, the term “impression” refers to the presentation or display of an advertisement, while the term “action” refers to a consumer's selection of a presented advertisement, purchase of an advertised product or service, or the like. In some embodiments, the amount payable to a user is fixed based on the number of impressions or access to social applications created by the user. For example, the monetization system may pay a creator of a social application $0.50 for every thousand impressions resulting from others' access to the social application. In some embodiments, the monetization system increases the amount payable to the creator, if a consumer takes some action with respect to a presented advertisement. For example, the monetization system may pay a creator $0.25 for each consumer that clicks on a presented advertisement. As another example, the monetization system may pay a creator $2 if a consumer not only clicks on a presented advertisement but also purchases the advertised product or service. In some embodiments, the amount payable to a created of a social application is a percentage of the actual revenue or amount paid by an advertiser to place the advertisement on the social application. For example, if an advertiser pays $30 for a sale resulting from presentation of an advertisement on a social application, the monetization system may pay the creator of the social application a 20% share of the revenue ($6). In some embodiments, the amount payable to a user varies. For example, the rate may vary based on the number or volume of applications created by a user, the traffic quality or performance of an application (e.g., the frequency that consumers accessing the application clicked on advertisements, purchase the advertised products or services, etc.), the geographic locations of consumers accessing an application (e.g., a higher rate may be paid for consumers located in the United States than for consumers located in Mexico), popularity of the application, the type of application, the category of application, and/or the like. Those skilled in the art will appreciate that the amount payable to a creator of a social application may be calculated based on any number of factors or combination of factors. As such, the examples of revenue share calculation should not be taken as restrictive.

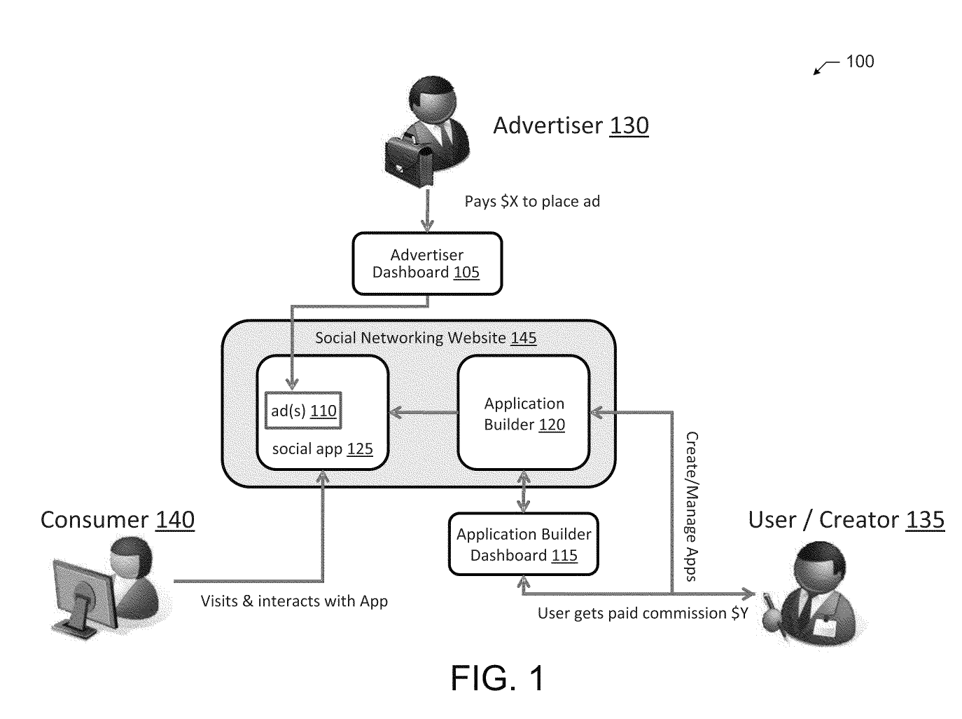

Before describing the monetization system in greater detail, it is useful to consider an environment in which the monetization system can be implemented. FIG. 1 is a high-level ecosystem diagram of various entities and computer systems that are part of, or interact with, a monetization system 100. In the illustrated embodiment, the monetization system 100 includes an advertiser dashboard 105, an application builder dashboard 115, and an application builder 120. Users (“creators”) 135 build social applications 125 with the application builder 120 for distribution on one or more social networks. An advertiser 130 places advertisements 110 in the system to be distributed with the social applications created by the creators 135 and consumed by other users (“consumers”) 140.

The advertiser 130 places advertisements 110 using the advertiser dashboard 105. The advertiser can customize an advertisement and specify the parameters of the advertisement and/or an advertisement campaign. Advertisements may be specified to run on specific types of social applications and/or based on a target user demographic, the user-generated content of the social application, characteristics of the consumer 140, and/or the like. For example, an advertiser may specify that a particular advertisement is to be placed on social applications that are accessed by female consumers, between the ages of twenty-five and thirty-five, and residing in the Midwest. Advertisers may prepay for advertisements to be placed on social applications and/or an advertiser's account may be charged retroactively for advertisements placed on social applications. For example, advertisers may be charged each time an advertisement is placed on a social application, each time an advertisement is selected (“clicked on”) by a user of a social application, on a periodic basis for all advertisements placed during the period, and/or when a threshold number of advertisements have been placed, etc. The amount payable by an advertiser may be fixed or may vary based on a number of factors, including the characteristics of the social application (type, content, popularity, etc.), demographics of the consumers (e.g., age, gender, location, etc.), actions taken with respect to a presented advertisement (display, selection, purchase, etc.), or the like. For example, as advertiser may pay rate of $1 for every thousand advertisements placed on trivia quiz applications that include the words dog or cat, and a rate of $0.75 for every thousand advertisements placed on any type of social application that includes the word pet. As another example, an advertiser may pay a rate of $0.50 for each advertisement clicked-on by a female consumer or a rate of $20 for each advertisement that resulted in a sale, lead, or transaction by any consumer. The amount payable by an advertiser may be a percentage of the advertiser's gross or net advertising revenue. For example, if an advertiser earns $100 from a sale resulting from presentation of an advertisement on a social application, the advertiser may pay a 30% share of the revenue ($30). Those skilled in the art will appreciate that the amount payable by an advertiser may be calculated based on any number of factors or combination of factors. As such, these examples should not be taken as restrictive.

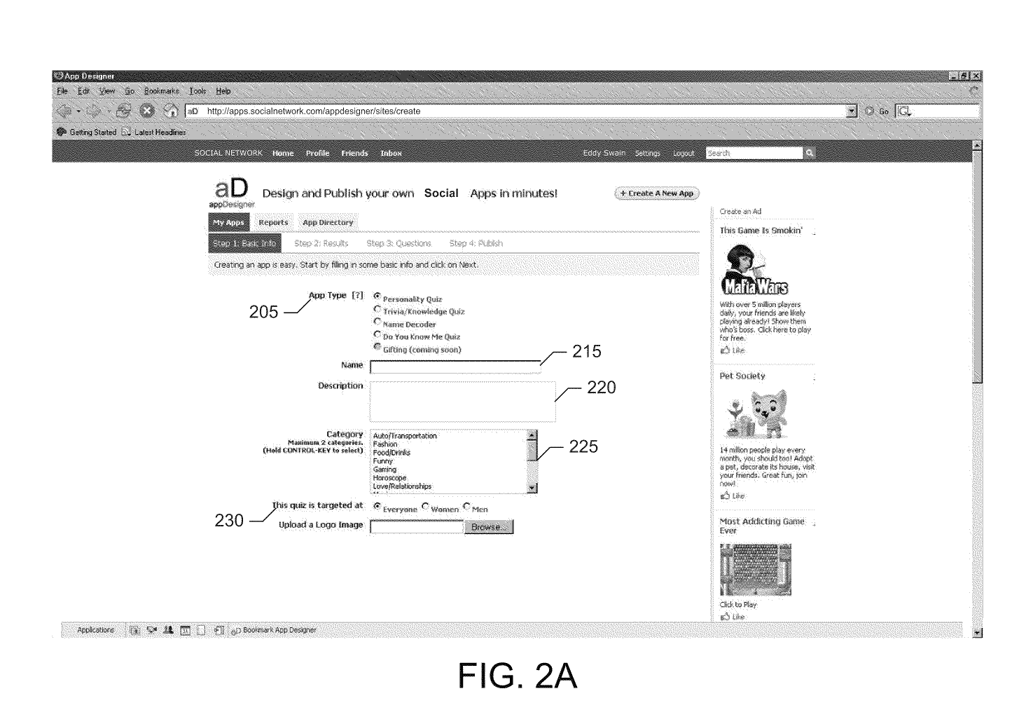

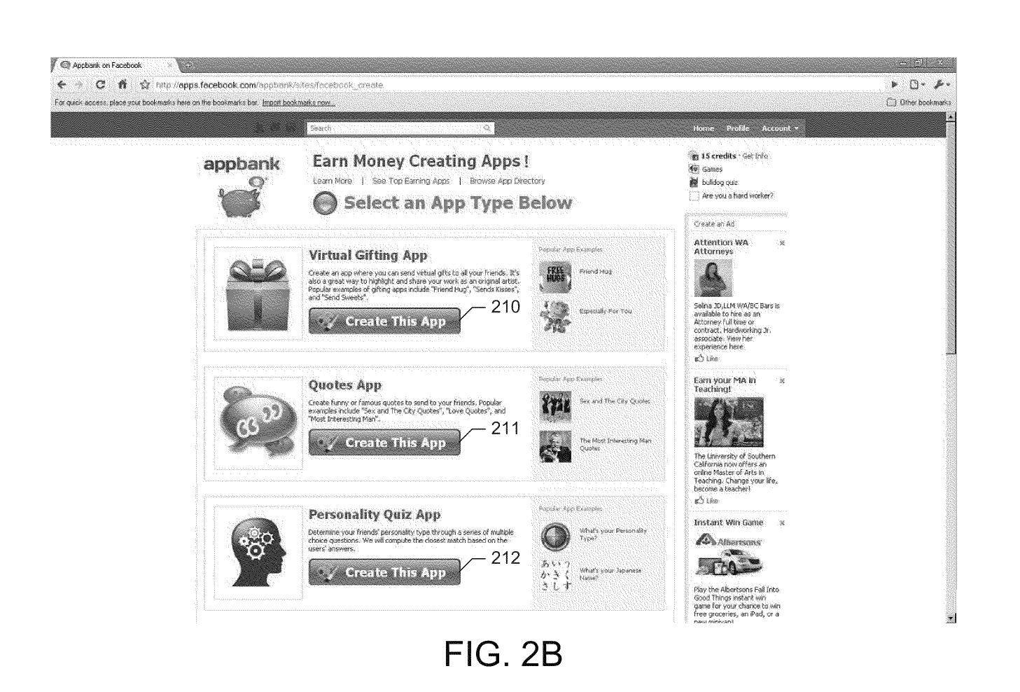

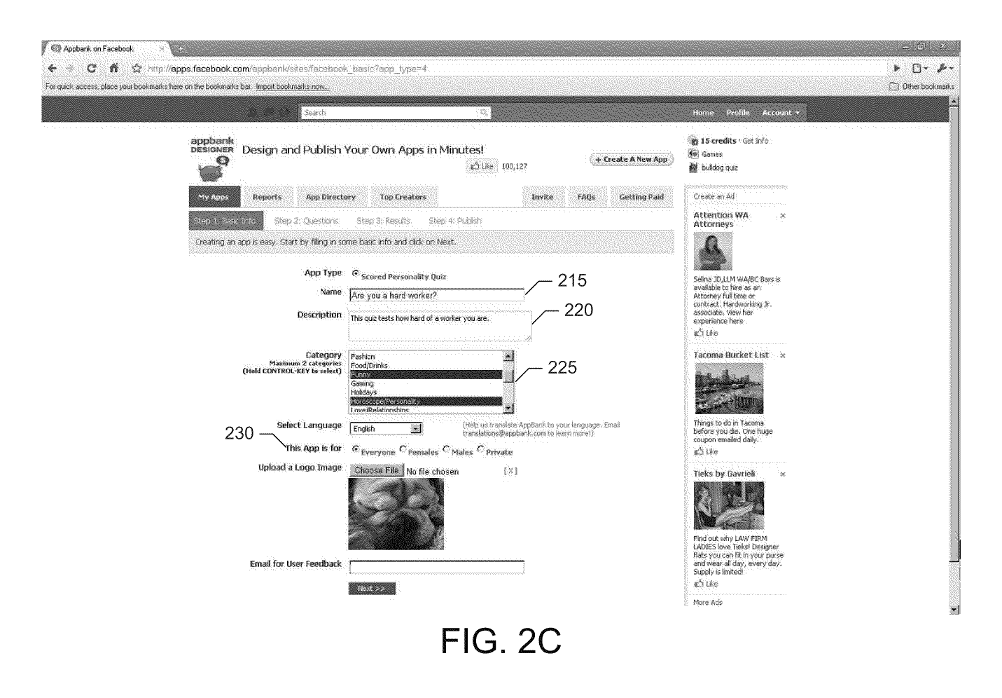

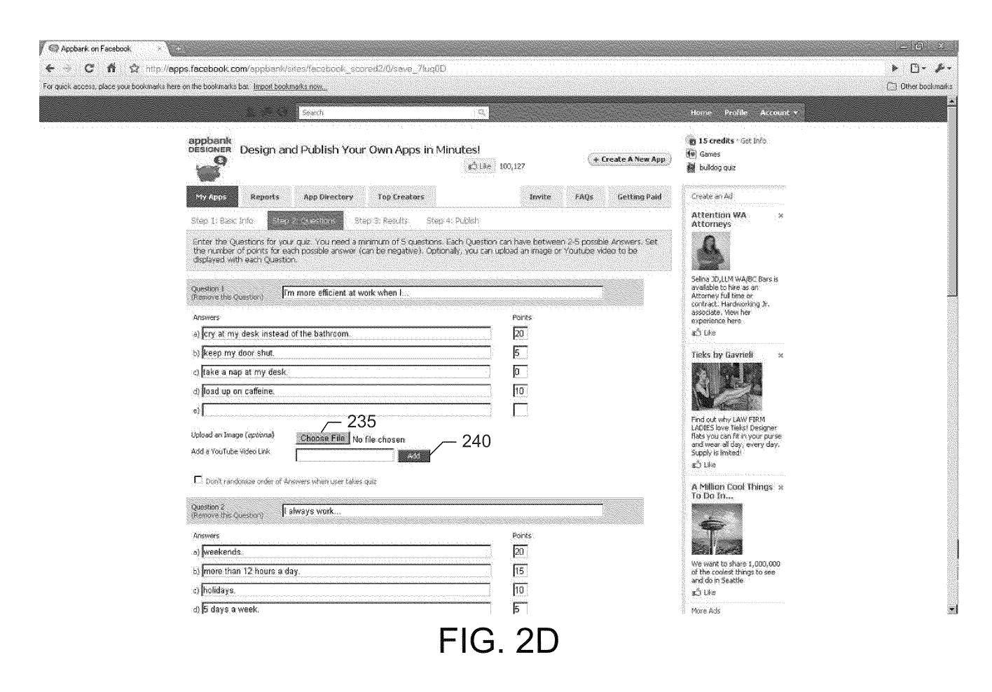

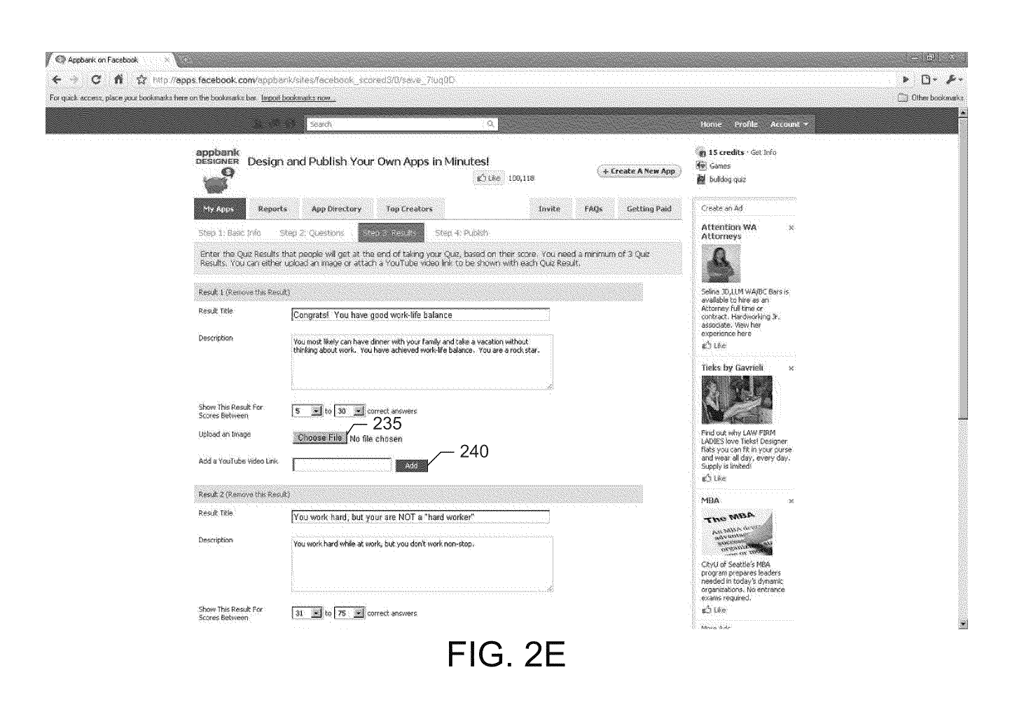

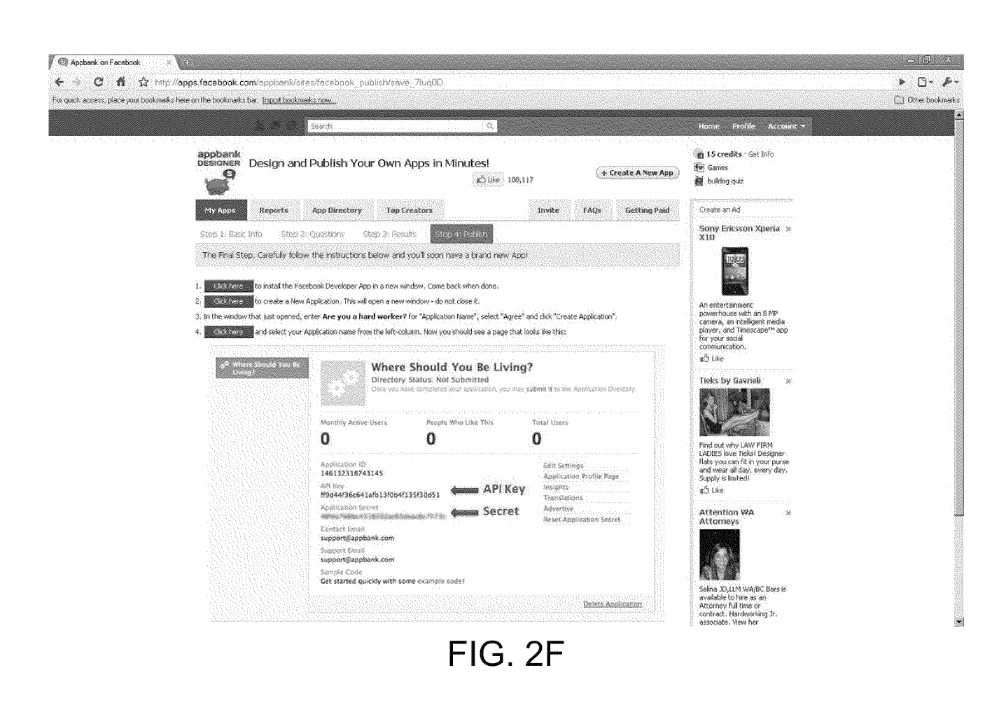

A user 135 uses the application builder 120 to create a social application. The application builder 120 provides an interface that enables a user 135 of a social networking website 145 to create a social application without requiring the user to have any technical training or programming knowledge. FIGS. 2A-2F show example interfaces of an application builder 120. In the embodiments illustrated in FIGS. 2A and 2B, the user (“creator”) selects an application type from a set of application templates and authors the content to be hosted by the monetization system. For example, as illustrated in FIG. 2A, the user selects an application type by choosing one of the application templates listed by radio control 205. In the illustrated screenshot, the “Personality Quiz” application template is selected by the user. As another example, as illustrated in FIG. 2B, the user selects (“clicks on”) one of controls 210-212 to select an application type. Those skilled in the art will appreciate that the application builder 120 may receive input from a user through a variety of controls and interfaces, such as via a form or page with fields to be filled in, pull-down menus or entries allowing one or more of several options to be selected, buttons, sliders, hypertext links or other known user interface tools for receiving user input. For example, as illustrated in FIGS. 2A and 2C, the user may provide a name and description of the social application using fields 215 and 220 and a categorization and target audience for the social application using option control 225 and radio control 230.

In some embodiments, the application builder 120 allows the user to customize their application content, interface, and/or functionality. For example, as illustrated in FIGS. 2D and 2E, when the user selects a scored personality quiz template, the user may specify the number of questions, the number of answers to each question, whether and how the answers are scored, and so on. The application builder 120 is not limited to text-based user-generated content. For example, as illustrated in FIG. 2D and 2E, the user may upload images and/or links to external content using controls 235 and 240. The social application 125 is then published within the social networking website 145. The social networking website 145 may be, for example, Facebook, MySpace, Bebo, Classmates, Flickr, Friendster, hi5, GamerDNA, Jaiku, LinkedIn, Ning, Twitter, Windows Live Spaces, Yelp, or the like. As illustrated in FIG. 2F, the application builder 120 provides an interface detailing the process to publish the social application within the social networking website 145.

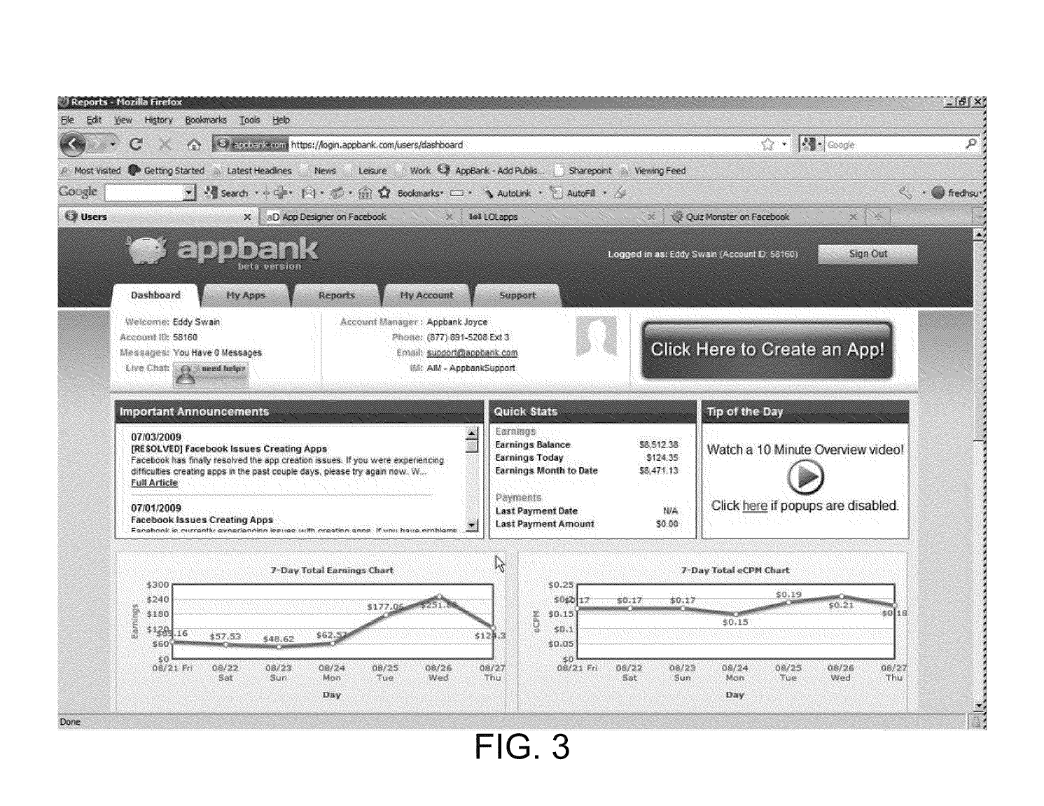

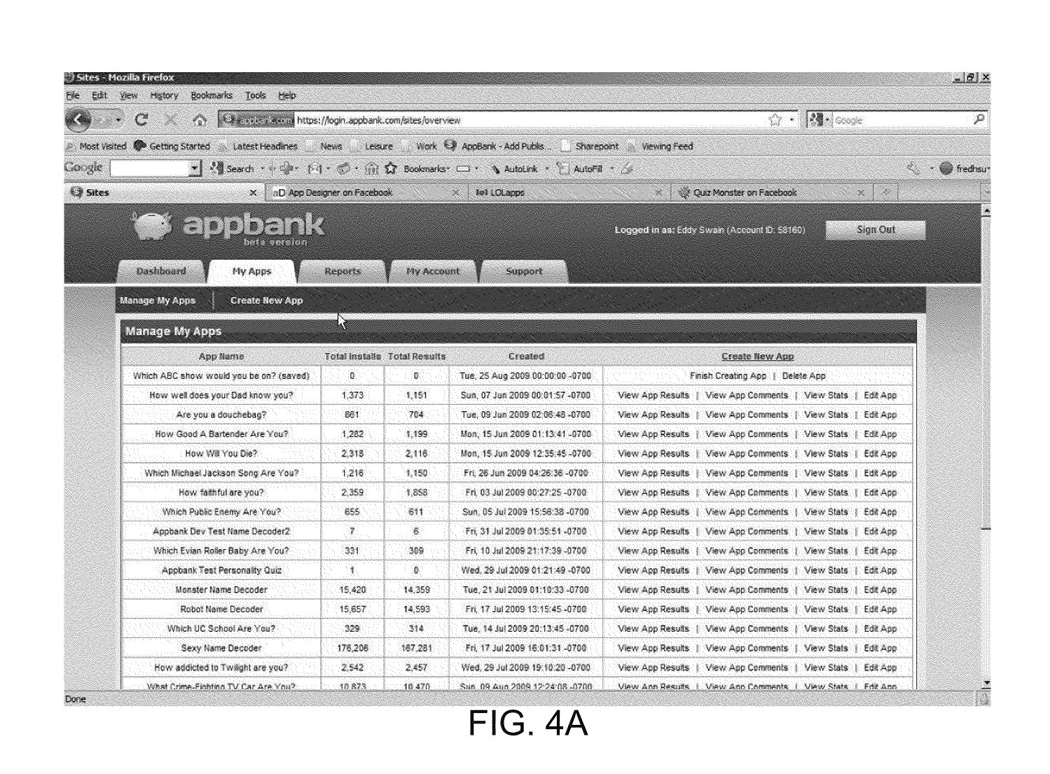

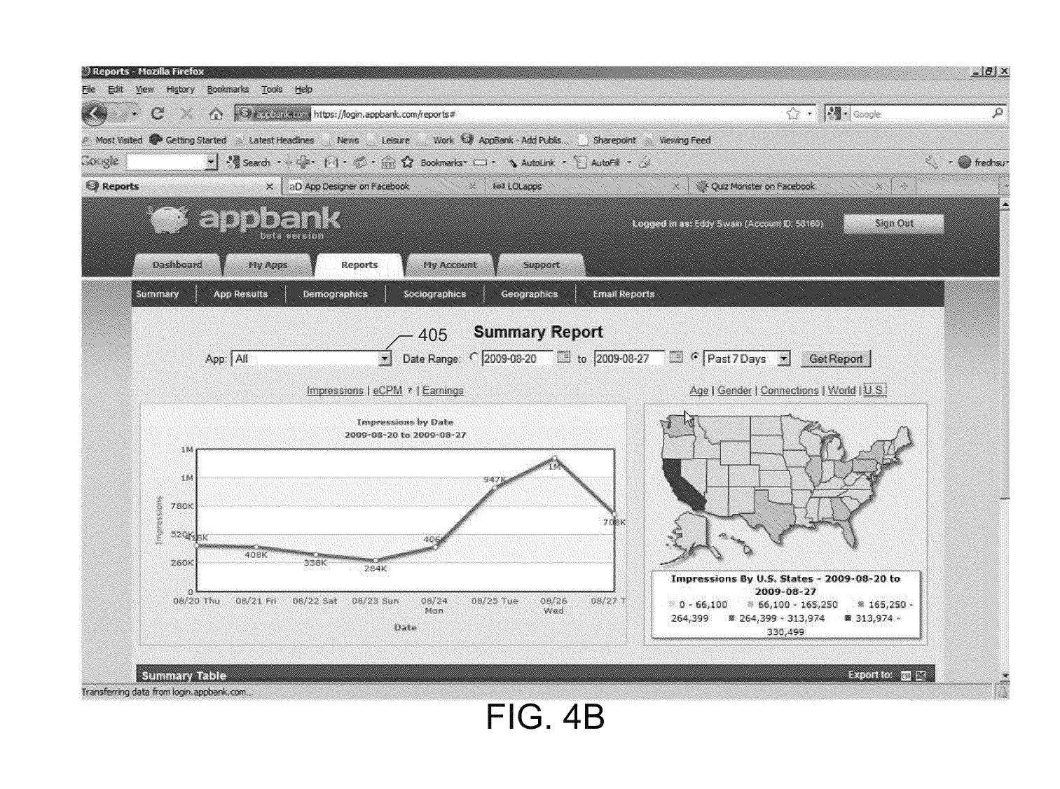

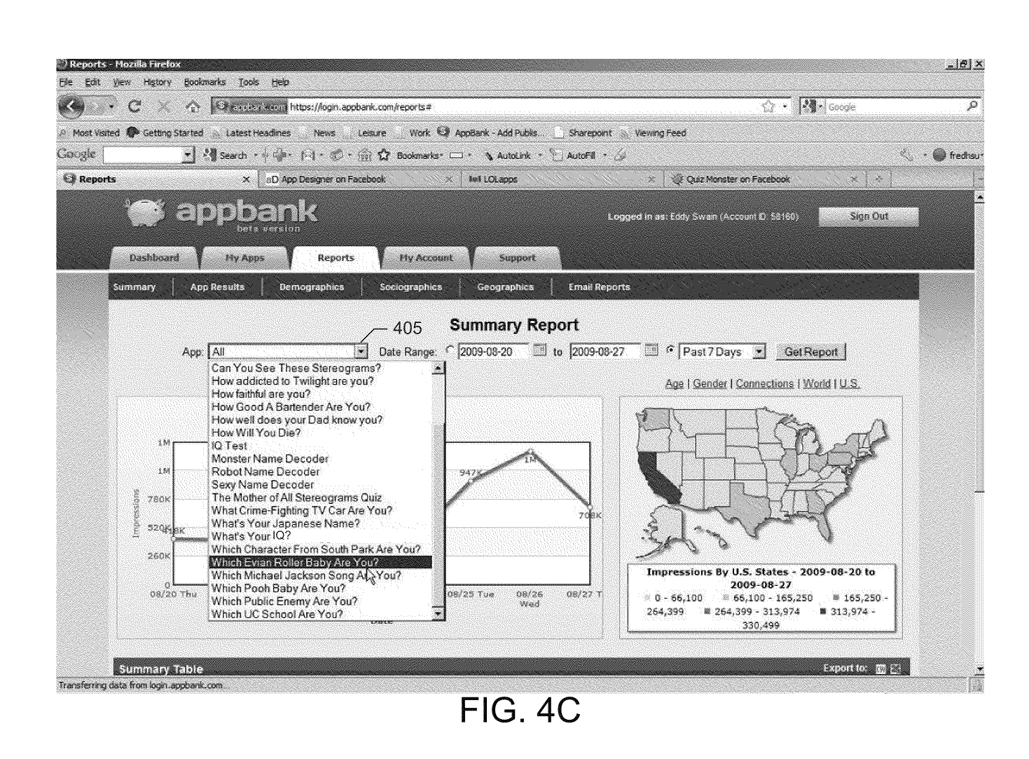

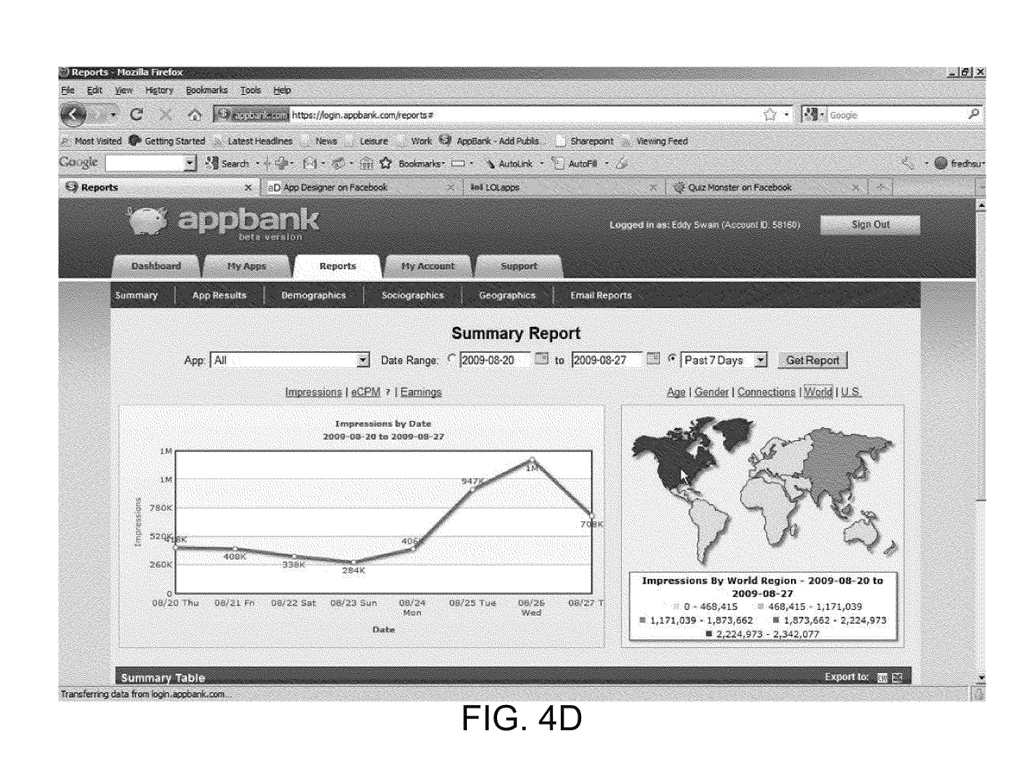

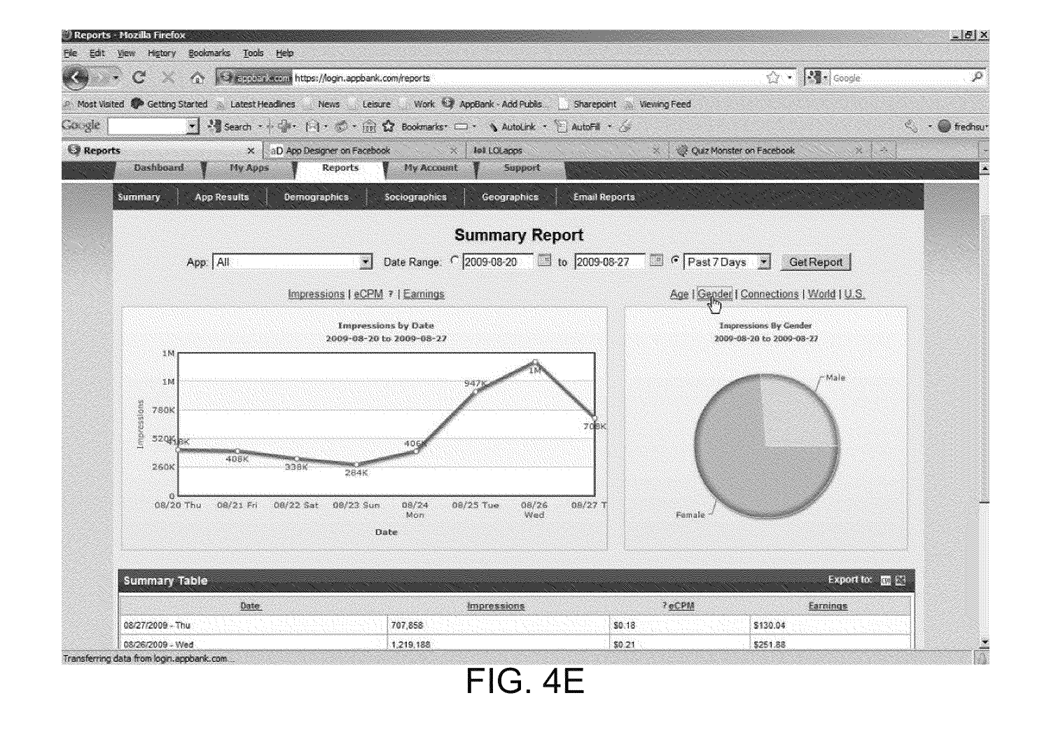

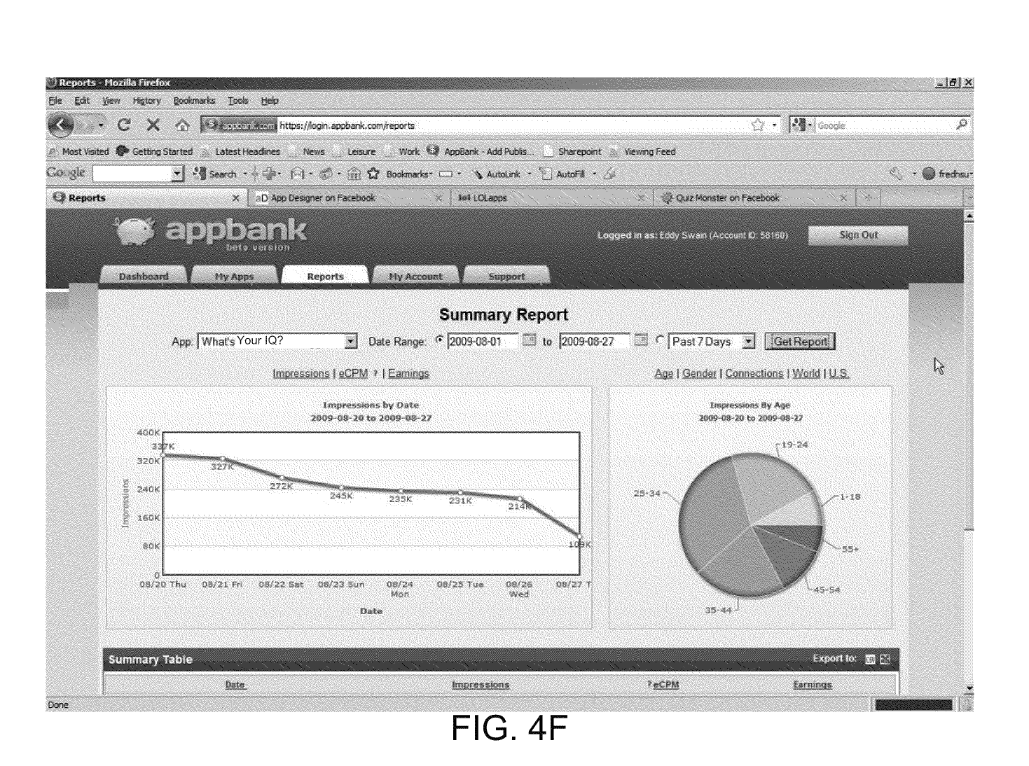

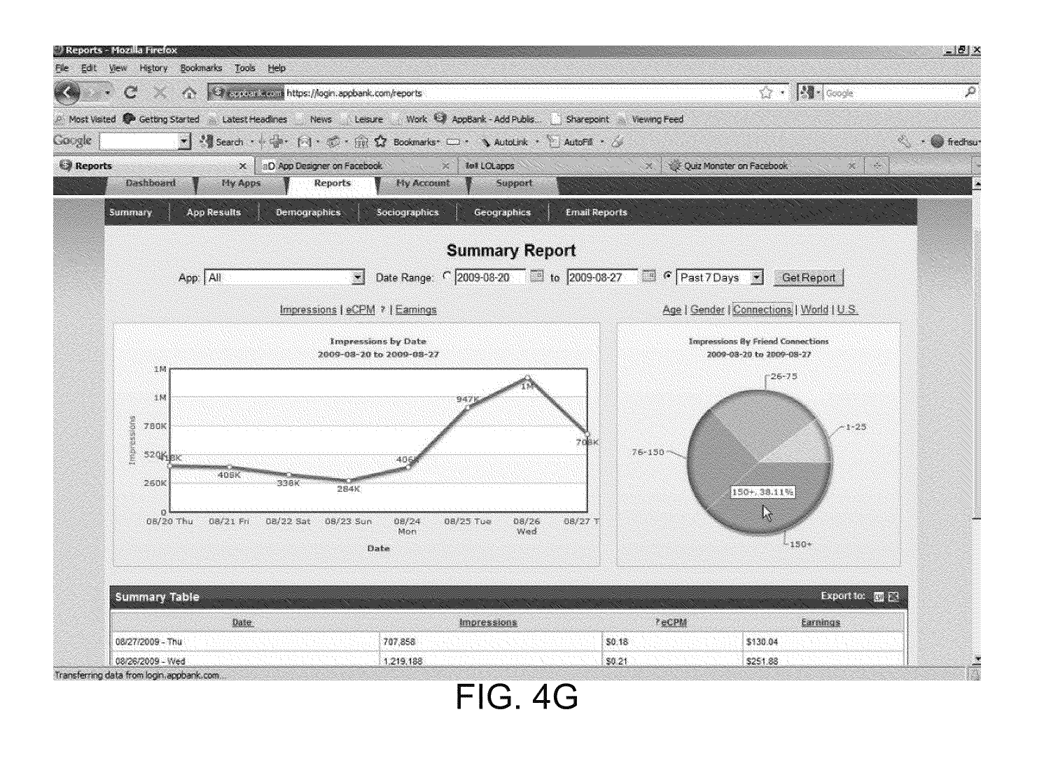

The application builder dashboard 115 provides an interface that enables a user 135 to manage and monitor his or her social applications. The application builder dashboard 115 may be accessed by a user 135 through the social networking website and/or the monetization system. FIG. 3 shows an example interface of an application dashboard. The user can view reports of application usage and earnings. FIGS. 4A-G show example reporting interfaces. FIG. 4A shows an example of a interface that provides a listing of each application created by the user 135. The interface identifies, for each application created by the user, the date the application was created, the number of times the application has been access or installed by another user of the social network service, and the results, if any. The interface further provides controls to access additional information for each application, such as comments by other users accessing the application, application statistics, etc. FIG. 4B shows an example interface that reports the number of impressions in the United States over a period of time for all application created by the user 135. As illustrated in FIG. 4C, the user can view the report for a particular social application by selecting control 405. FIG. 4D shows an example interface that reports the number of impressions worldwide over a period of time for all application created by the user 135. FIG. 4E shows an example interface that reports the number of impressions based on the gender of users accessing applications created by the user 135. FIG. 4F shows an example interface that reports the number of impressions based on the ages of users accessing applications created by the user 135. FIG. 4G shows an example interface that reports the number of impressions based on the connection of users accessing applications created by the user 135.

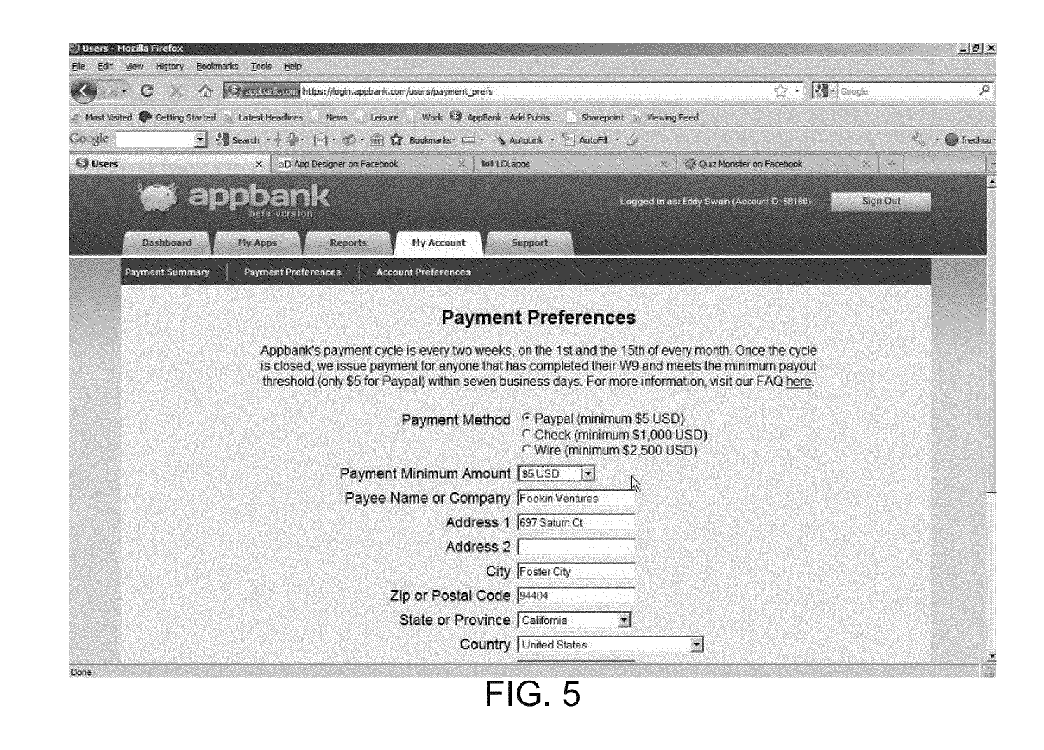

In some embodiments, the application dashboard includes an interface that enables the user 135 to specify payment preferences. FIG. 5 shows an example payment interface. The payment interface provides a display and controls for the user 135 to monitor his account details such as current balances and upcoming payments, and configure payment details, such as accounts to credit, payment methods, and payment schedules.

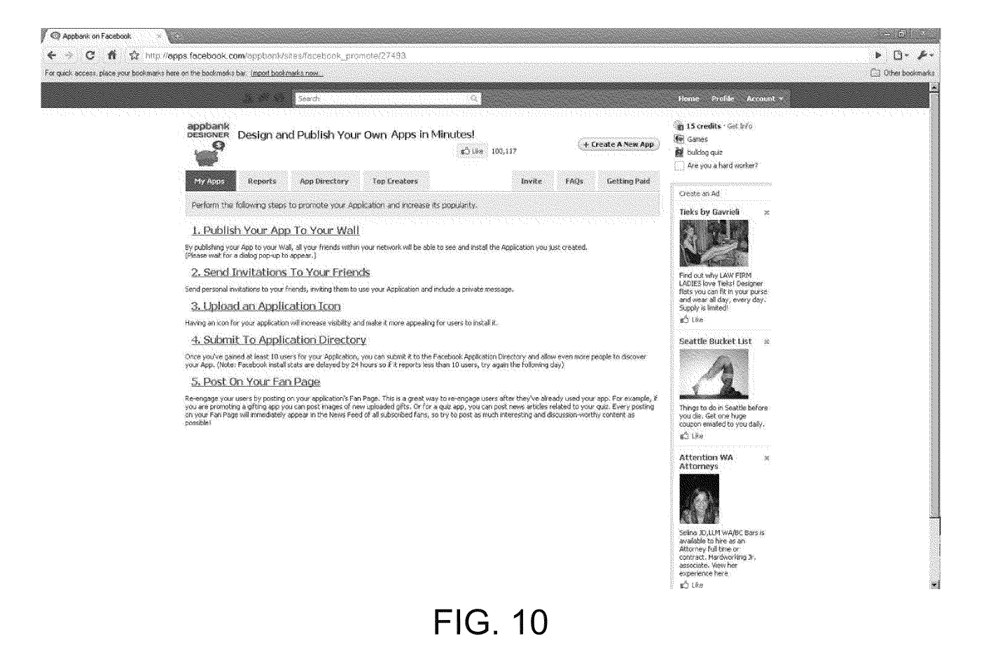

Returning to FIG. 1, after a social application 125 is published by the application creator 135, the social application may be shared with other “consumer” users 140 of the social networking website 145. FIG. 10 shows an example interface provided by the application builder 120 to enable an application creator to share or promote an application. Some social networks require that an application be “installed” by a consumer. Typically, the installation of an application requires a consumer to grant the social application access to his or her profile and/or accept other terms of use. Consumer users 140 may also share the social application with other consumer users. Interactions with the social application 125 may result in one or more advertisements 110 being shown to the consumer 140. An interaction may include an impression, click through, or the like. The advertiser 130 is charged based on the interactions of consumer 140 with the social application 125, and a share of the revenue is paid to the user 135 that created the social application 125. For example, the monetization system may include a payment system (not shown) that monitors the placement of advertisements on social applications and calculates the revenue share owed to users 135. The monetization system tracks the number of times that each advertisement is placed on a social application created by the user and/or the number of times that each advertisement is selected by a consumer (e.g., clicked-on). The monetization system may also track the circumstances surrounding the presentation of each advertisement (e.g., the demographics of the consumer, the time and day of display, the social network on which the advertisement is displayed). The revenue share owed to a user may be calculated each time the advertisement is selected or displayed, or the revenue share may be calculated on a sporadic basis, on a periodic basis, when a threshold number of advertisements have been placed, during periods of low activity, etc. In some embodiments, the monetization system enables users 135 to establish a payment schedule and/or payment type (e.g., paypal, check, wire, etc.). For example, a user 135 may schedule payments when a threshold amount is earned, on a periodic basis (e.g., every two weeks), by request, and so on. In some embodiments, if a user 135 does not establish a payment schedule, the monetization system includes a default payment schedule. In some embodiments, the monetization system requires users 135 to submit tax information (e.g., a IRS W9 form) for tax reporting purposes. In some embodiments, an application creator can elect to forego or return a revenue share (e.g., $5) earned by the creator in exchange for promotion of the application by the monetization system to other consumers. Promotion of an application by the monetization system may increase the reach or popularity of the application, thereby increasing the earning potential of the application. In some embodiments, the monetization system implements an application referral program. For example, if a consumer recommends a social application to another consumer and that consumer actually accesses the application, then the consumer that recommended the application may earn a share of revenue based on that consumer's access to the application and/or other consumers' access to the application resulting from the recommendation.

It is noted that the number of social applications 125, social networking websites 145, advertisers 130, creator users 135, and/or consumer users 140 is not limited to the number or ratio of those illustrated in FIG. 1. The monetization system is designed to scale to include thousands or millions of users. Moreover, while various embodiments are described in terms of the ecosystem described above, those skilled in the art will appreciate that the monetization system may be implemented in a variety of other environments including a single, monolithic computer system, a pool of servers, as well as various other combinations of computer systems or similar devices connected in various ways. For example, in some embodiments, the monetization system is owned and/or operated by the same entity as the social network service, even though it is not illustrated as such in FIG. 1. As another example, an application builder may support multiple social networking websites, even though it is not illustrated as such in FIG. 1. Those skilled in the art will further appreciate that the monetization system may include other types of computers and/or devices not specifically illustrated. For example, the monetization system 100 may include a payment system (not shown) that distributes payments, or facilitates the distribution of payments, by the monetization system to users 135.

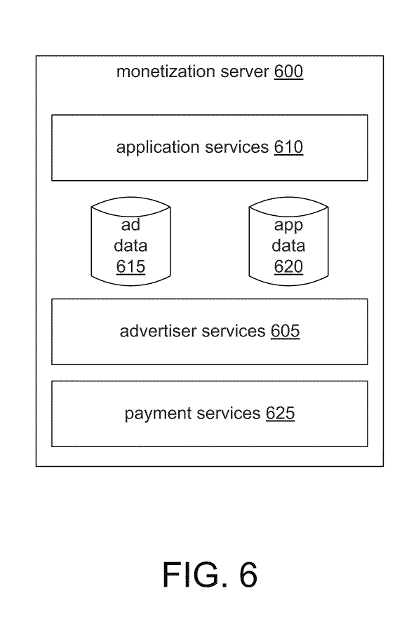

FIG. 6 is a block diagram that illustrates various components or services of a monetization server 600. In the illustrated embodiment, the monetization server 600 includes advertiser services 605, application services 610, and payment services 625. Advertiser services 605 enable advertisers to submit advertisements and/or advertisement campaigns. In some embodiments, the advertiser services 605 enable an advertiser to specify parameters that define how an advertisement is to be used in connection with user-generated social applications managed by the monetization server 600. Advertisements and/or advertisement parameters are stored in an advertisement data storage system 615. Application services 610 enable a user of a social network service to manage social applications created by the user and to get paid based on other users' interaction with the social applications. The original content of a social application generated by a user is stored in an application data storage system 620. Social applications managed by the monetization server 600 can be accessed by users (“consumers”) through one or more social networks. When a social application is requested, the social application is provided together with one or more advertisements. Payment services 625 are used to monitor the placement of advertisements on a social application and to calculate the revenue share owed to the creator of the social application. Payment services 625 may also monitor the placement of advertisements to determine whether a number of prepaid advertisements has been reached and/or to calculate the amount owed by an advertiser. Advertisement and application data storage systems 615, 620 may be, for example, magnetic disks, optical disks such as CD-ROM or DVD based storage, magneto-optical (MO) storage, or any other type of non-volatile storage devices suitable for storing large quantities of data. The storage systems 615, 620 can be organized as a Redundant Array of Inexpensive Disks (RAID), in which case the monetization server 600 accesses the storage systems using one or more well-known RAID protocols. Those skilled in the art will appreciate that the components and services shown in FIG. 6 may be altered in a variety of ways. For example, a function of certain component or service may be performed by another component or service; certain components or services may be omitted; other components or services may be included; etc.

The monetization server 600 may communicate with users of a social network, advertisers, and/or one or more social networks though a network, such as a wide area network (WAN) (e.g., a private or public network like the Internet), a local area network (LAN), and/or a cellular network (e.g., a GSM network, a GPRS network, a CDMA network, EDGE network, etc.). Computers used to communicate with the monetization server 600 may be, for example, a personal computer (PC), a mobile device, workstation, server, etc. When operated by a user, each computer typically includes a browser and/or another software application that enables the operator of the computer to access services and/or data provided by the monetization server 600 via a web interface. Details regarding client computers are known and well documented, and thus need not be described in detail in order to gain an understanding of the operation of the monetization system.

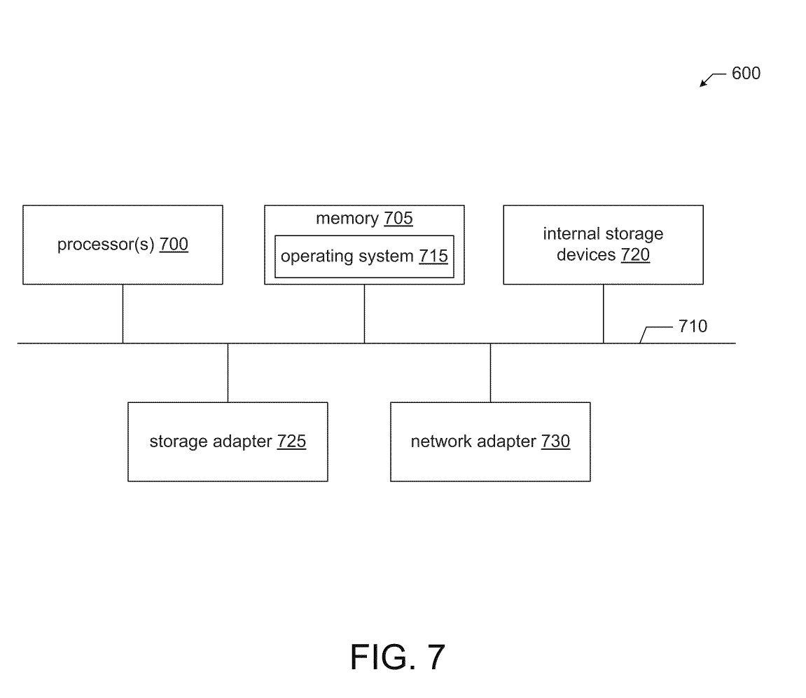

FIG. 7 is a block diagram showing an example architecture of a monetization server 600. It is noted that certain well-known structures and functions have not been shown or described in detail to avoid obscuring the description. The monetization server 600 includes one or more processors 700 and memory 705 coupled to an interconnect system 710. The interconnect system 710 shown in FIG. 7 is an abstraction that represents any one or more separate physical buses and/or point-to-point connections, connected by appropriate bridges, adapters and/or controllers. The interconnect system 710 may include, for example, a system bus, a form of Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 700 are the central processing units (“CPUs”) of the monetization server 600 and, thus, control its overall operation. In some embodiments, the processors 700 accomplish this by executing software stored in memory 705. In some embodiments, the monetization server 600 includes a processor 700 having two or more independent cores in a package composed of a single integrated circuit (referred to as a “die”), one or more dies packaged together, multiple packages, and so on. In some embodiments, the monetization server 600 includes a hyper-threaded processor 700 that, despite having only a single core, is capable of performing as a multi-core processor. A processor 700 may be, or may include, one or more programmable general-purpose or special-purpose microprocessors, digital signal processors (“DSPs”) programmable controllers, application specific integrated circuits (“ASICs”), programmable logic devices (“PLDs”), or the like, or a combination of such devices.

Memory 705 includes the main memory of the monetization server 600. Memory 705 includes any form of volatile, nonvolatile, removable, and non-removable computer-readable storage media, or any combination of such media devices that are capable of storing information such as computer-readable instructions, data structures, program modules, or other data of the monetization server 600. Memory 705 stores (among other things) an operating system 715. In some embodiments, the operating system 715 is a Microsoft Windows® operating system, while in other embodiments the operation system 715 is a Linux or Unix operating system. It is noted, however, that the technology introduced herein does not depend on the operating system implemented by the monetization server 600.

Also connected to the processors 700 through the interconnect system 710 are one or more internal storage devices 720, a storage adapter 725 and a network adapter 730. The internal storage devices 720 may be or include any computer-readable storage medium for storing data, such as one or more disks. As used herein, the term “disk” refers to any computer-readable storage medium including volatile (e.g., RAM), nonvolatile (e.g., ROM, Flash, etc.), removable, and non-removable media, or any combination of such media devices that are capable of storing information such as computer-readable instructions, data structures, program modules, or other data. It is further noted that the term “disk” may refer to physical or virtualized computer-readable storage media. The storage adapter 725 allows the monetization server 600 to access the information storage systems 615, 620 and may be, for example, a Fibre Channel adapter, a SCSI adapter, or the like. The network adapter 730 provides the monetization server 600 with the ability to communicate with remote devices, such as the social network service, advertiser computers, and/or user computers over a network and may be, for example, an Ethernet adapter, a Fibre Channel adapter, or the like.

While computer systems configured as described above are typically used to support the operation of the monetization system, those skilled in the art will appreciate that a monetization server may be implemented using devices of various types and configurations, and having various components.

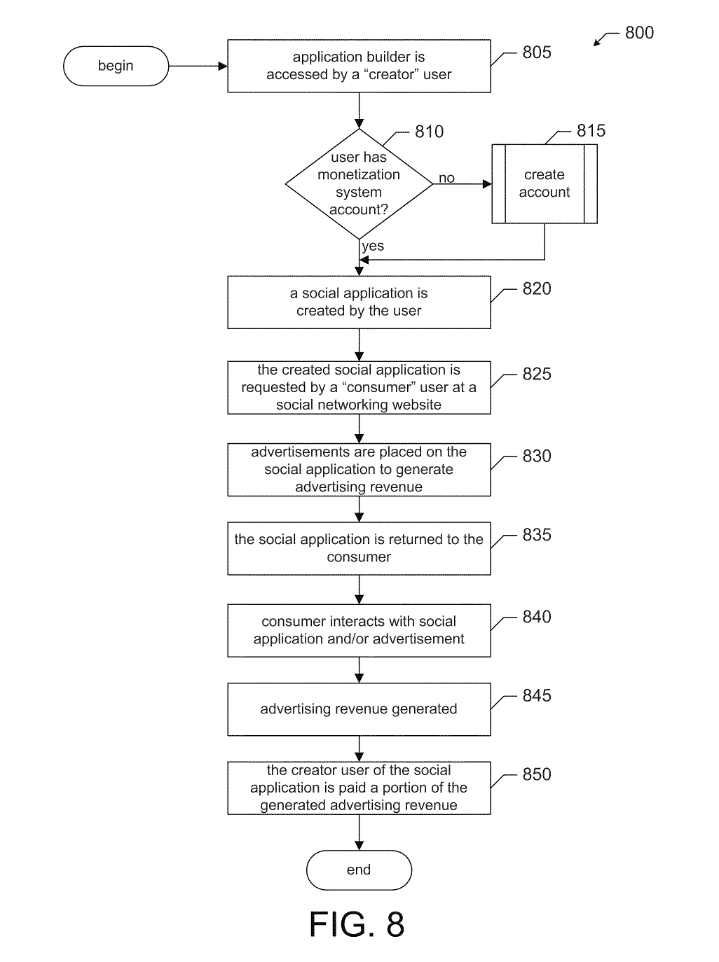

FIG. 8 is a flow chart of an application monetization process 800. In some embodiments, all or a portion of the steps are performed by the monetization server 600. Those skilled in the art will appreciate that the steps shown in FIG. 8 may be altered in a variety of ways. For example, the order of certain steps may be rearranged; some steps may be performed in parallel; certain shown steps may be omitted; or other steps may be included; etc.

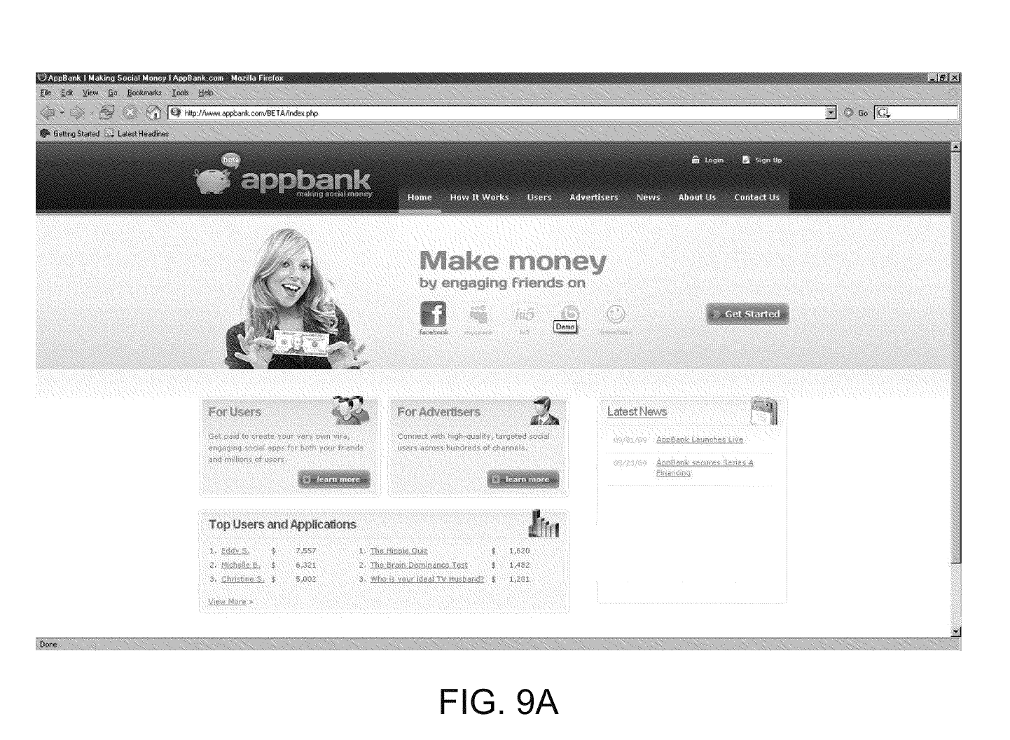

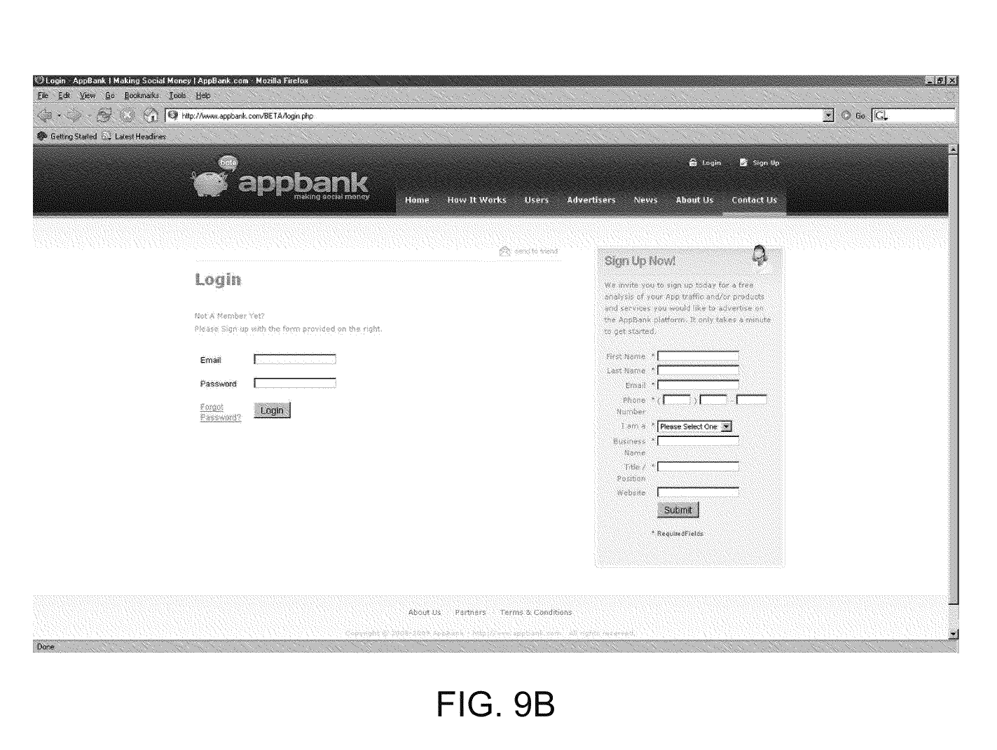

In step 805, an application builder is accessed by a user who desires to create a social application. The application builder may be accessed through a social networking website and/or a website associated with the monetization system using a browser application, for example. In step 810, if the user does not have an account established with the monetization system, then the user is directed to create an account in step 815, else the process continues to step 820. FIGS. 9A-9B show example interfaces that the user may access to establish an account with the monetization system.

In step 820, a social application is created by the user. The application builder provides an interface that alleviates the technical expertise required to create an application using the APIs provided by the social networking website. For example, the application builder may include a number of application types that the user may select (e.g., personality quiz, trivia quiz, name decoder, gifts, games, etc.). The application builder manages the social application creation process. The user may submit various types of content (e.g., text, images, video, etc.) that are incorporated into, or associated with, the selected social application. After the social application is complete, the social application is published at one or more social networking websites. Publication typically involves the social networking website associating the social application with one or more unique pieces of information, such as an API key, an API secret key, an application root URL within the social networking site, etc. The publication information is used to manage the social application by the monetization system (e.g., host, place advertisements, track usage, etc.). For example, the social network service may provide publication information to the monetization server in response to a request by a consumer to access a social application hosted by the monetization system. The application creator 135 and/or the application builder 120 may communicate the publication information to the monetization system, so that the monetization system can correlate the information provided by the social networking site to a particular instance of the application. In, some embodiments, when a social application is published, the application creator is presented with an interface to notify his or her connections (e.g., friends, family, colleagues, etc.) of the application. FIG. 10 shows an example interface that a user may access to notify other consumers of a social application created by the user.

In step 825, the social application is requested by a “consumer” user at a social networking website. In step 830, one or more advertisements are placed on the social application by the monetization system. Advertisements may be placed on a social application based on the type of application requested, the user-generated content of the requested application (e.g., based on keywords contained in the application or other analysis of the application content), characteristics of the consumer, characteristics of the creator, and/or a target user demographic of the user, etc. The monetization system may gather characteristics of a consumer from the consumer's social network profile, IP address, by observing behavior of the consumer with respect to other social applications and/or advertisements, and/or the like. In step 835, the social application is provided to the consumer. In step 840, the consumer views or interacts with the social application and/or an advertisement placed on the social application. In step 845, a share of the advertising revenue is calculated based on the interaction. In step 850, the user that created the social application is credited for a portion of the generated advertising revenue. For example, the monetization system may credit the user's account to reflect the consumer interaction. Then the process 800 ends. It is noted that the monetization system may loop through steps 830-850 each time the social application is requested. As a result, the creator of the social application is compensated for the original content he or she created.

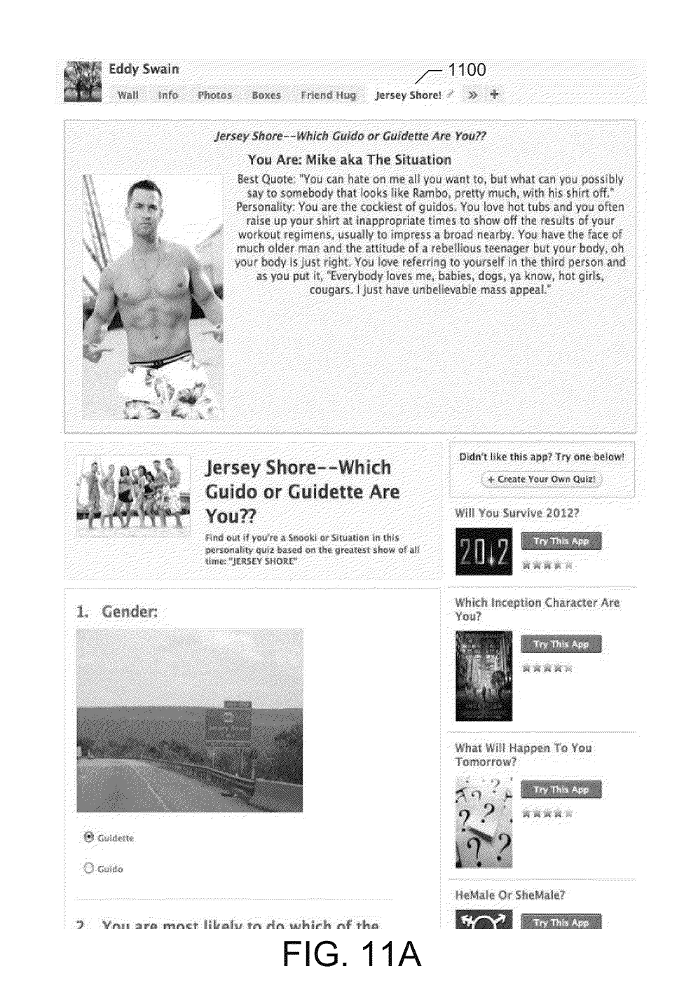

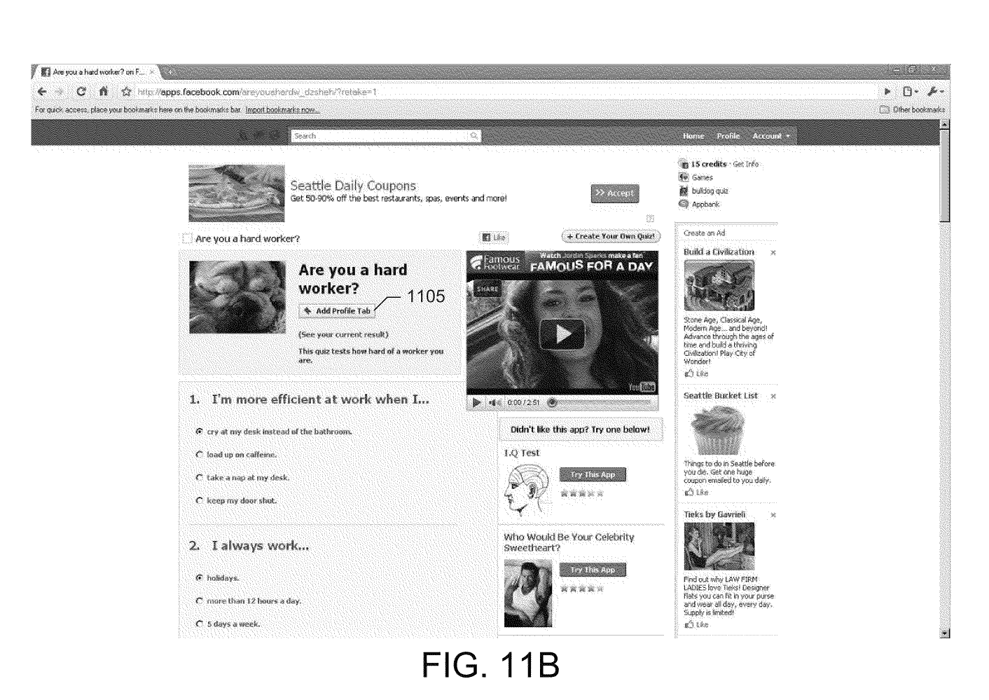

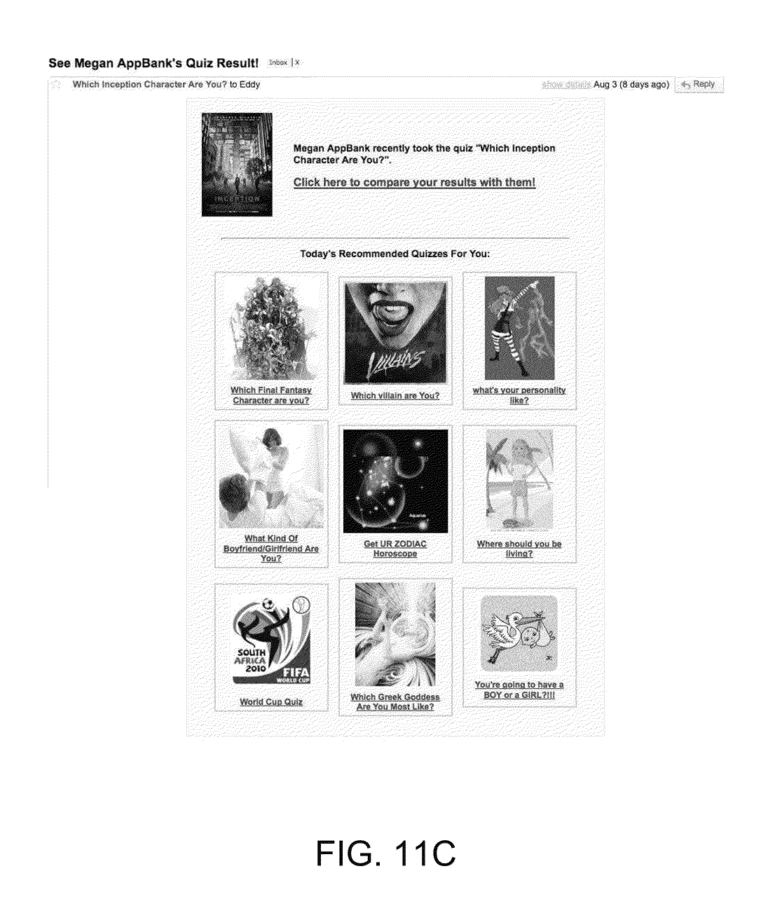

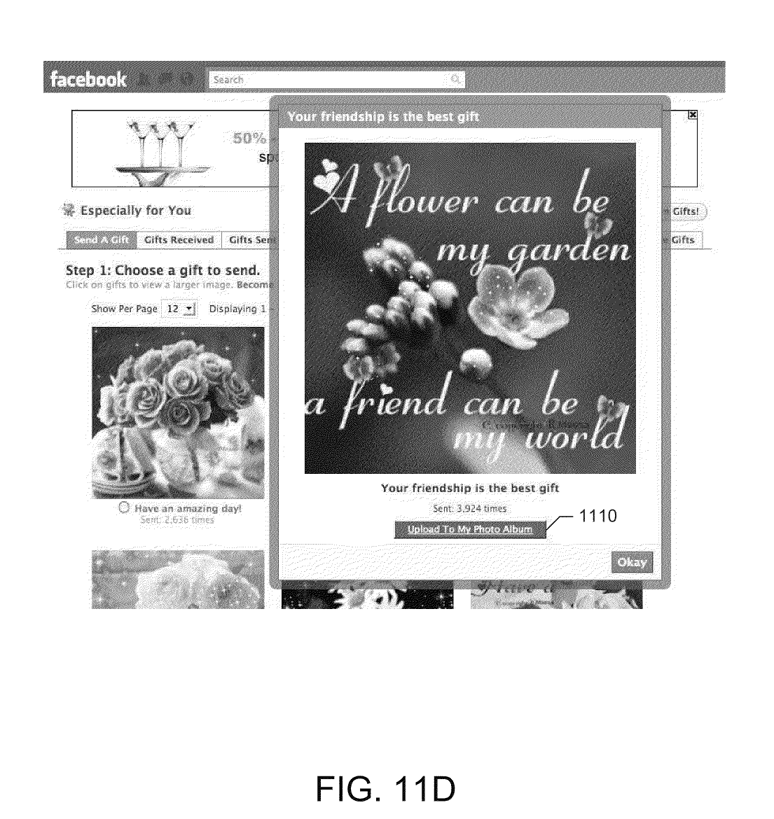

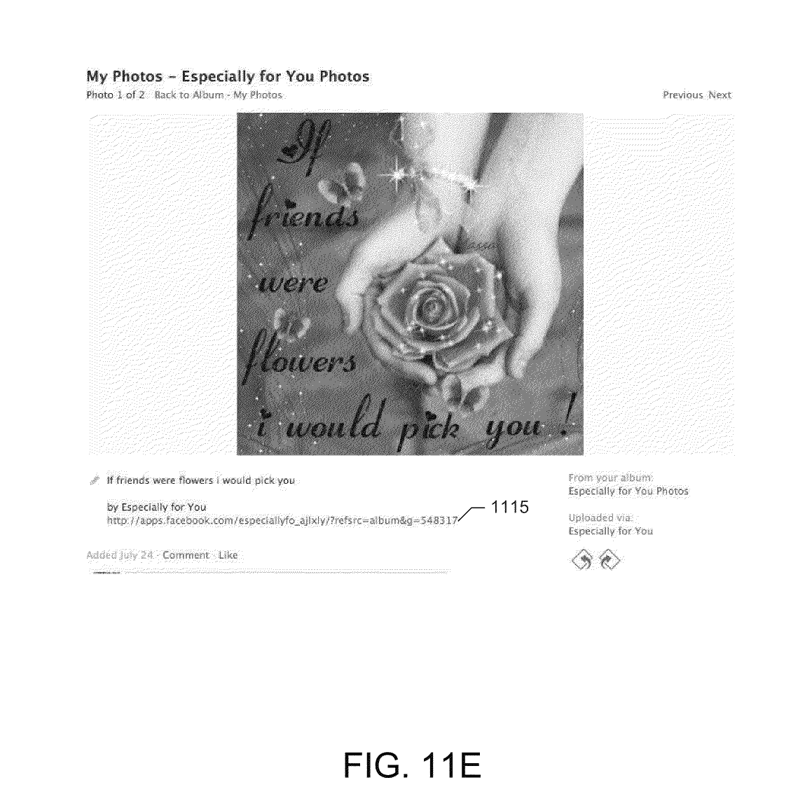

In some embodiments, the monetization system implements one or more techniques to promote and/or increase the virility of social applications created by users 135. For example, the application builder 120 may include a control to enable the creator of a social application to create a new page or profile tab that allows other users of the social network 145 to preview their application. FIG. 11A shows an example interface of a social application tab 1100 that has been added to a user's profile. In some embodiments, other users (“consumers”) of the social network service can add the application to their profile. For example, as illustrated in FIG. 11B, the social application includes a control 1105 to enable a consumer accessing the social application to add the application to their profile.

In some embodiments, to increase the virility of a social application, the monetization system enables a user of a social network service to share a social application with her connections (e.g., friends) by generating a email with a link to the social application. FIG. 11C shows an example message that is generated by the monetization system to promote a social application. In the illustrated embodiment, the message includes links to other social applications that are recommended to the recipient. In some embodiments, the monetization system randomly selects the other social applications to recommend; while in other embodiments, the selection is based on characteristics of the recipient, the sender, the shared social application, and/or the like. For example, the monetization system recommends social applications created by the connections of the recipient. As another example, the monetization system may recommend social applications that, if accessed by the recipient, will increase the amount payable by an advertiser for presentation of a particular advertisement.

In some embodiments, to increase the virility of a social application, the monetization system enables consumers of the social application to add user-generated content from the social application to their profile. FIG. 11D shows an example of a gifting application that allows consumers to upload user-generated content (e.g., “gift images”) from the social application to the consumers' personal photo album on the social network website by selecting control 1110. In the embodiment illustrated in FIG. 11E, the uploaded user-generated content includes a link 1115 to the social application.

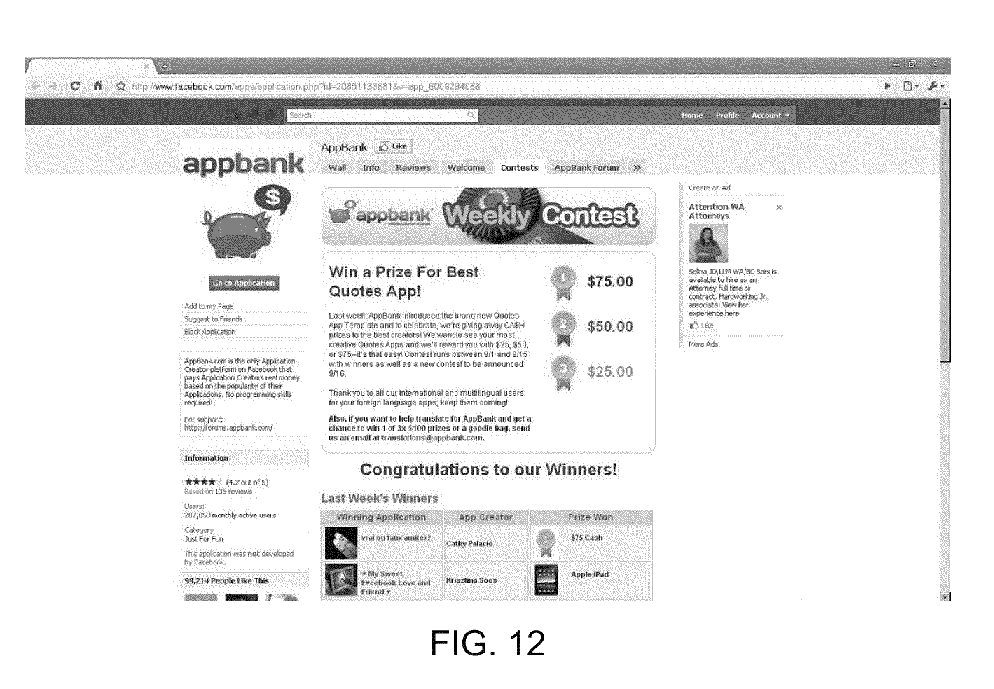

In some embodiments, the monetization system compensates creators by holding social application contests. Such contests may compensate users based on objective and/or subjective criteria. For example, the monetization system may reward the user that creates the top earning social application for a specific period of time. As another example, the monetization system may reward the user that creates the most creative “television show” quiz application. Social application contests may be held on a sporadic basis or on a periodic basis (e.g., monthly, weekly, yearly, etc.). For example, the monetization system may hold weekly contests and/or may hold contests when a new social application template is released. The winner of a social application contest may receive monetary compensation and/or other prizes (e.g., electronics, jewelry, airfare, hotel reservations, concert tickets, etc.). Such contests not only encourage users to create social applications but also reward users for high quality user-generated content. FIG. 12 shows an example interface of a social application contest implemented by the monetization system.

It will be appreciated by those skilled in the art that the above-described monetization system may be straightforwardly adapted or extended in various ways. For example, it will be appreciated that the monetization system described herein may be integrated with a particular social network service, adapted to a standalone application, or modified to include new content types. While the foregoing description makes reference to particular embodiments, the scope of the invention is defined solely by the claims that follow and the elements recited therein.

We claim:

1. A computer-implemented monetization system to compensate a user of a social network service for content generated by the user, the monetization system comprising:
an application builder interface configured to:
receive, from a user, a selection of a social application template;
receive, from the user, user-generated content; and
create a social application for distribution to other users of a social network service, wherein the social application is created from the received user-generated content in accordance with the selected social application template;
a distribution component configured to receive, from another user, a request to access the social application via the social network service and to respond to the request with an instance of the social application that includes one or more advertisements;
a monitor component configured to detect the inclusion of the one or more advertisements with the distributed social application; and
an accounting component configured to calculate compensation payable to the user based on the detected inclusion of the one or more advertisements.

2. The monetization system of claim 1 further comprising an advertisement selection component configured to select the one or more advertisements that are included in the response to the request to access the social application.

3. The monetization system of claim 2 wherein the one or more advertisements are selected based on characteristics of the user requesting access to the social application.

4. The monetization system of claim 2 wherein the one or more advertisements are selected based on characteristics of the user-generated content of the social application.

5. The monetization system of claim 1 wherein the monitor component is further configured to detect the selection of an advertisement displayed in conjunction with the instance of the social application.

6. The monetization system of claim 5 wherein the accounting component is further configured to increase the compensation payable to the user in response to the detected selection of the advertisement by the monitoring component.

7. The monetization system of claim 1 wherein the application builder interface is accessed through the social network service.

8. The monetization system of claim 1 wherein the social network service and the monetization system are operated by different entities, and wherein the operator of the social network service has no ownership of, or control over, the operator of the monetization system.

9. The monetization system of claim 1 further comprising a reporting interface configured to display statistics pertaining to access to the social application by other users of the social network service.

10. The monetization system of claim 9 wherein the displayed statistics identify the demographics of the other users that have accessed the social application in aggregated form.

11. The monetization system of claim 10 wherein the demographics are selected from the group consisting of: gender, age, geographic location, and social network connections.

12. The monetization system of claim 1 further comprising an advertiser interface configured to receive an advertisement from an advertiser, wherein the accounting component is further configured to calculate compensation owed by the advertiser in response to the monitoring component detecting distribution of the social application with the received advertisement

13. The system of claim 1 wherein the social application template is selected from the group consisting of: a quiz application template, a quote application template, a trivia application template, a name decoder application template, a puzzle application template, a gifting application template, and a competitive gaming application template.

14. A computer-readable storage medium encoded with computer-executable instructions to compensate a user of a social network service for revenue generated from advertisements associated with content generated by the user, the computer-readable storage medium comprising:
instructions to receive a first request from a first user to create a social application for distribution to other users of a social network service, and wherein the first request includes user-generated content;
instructions to create a social application by associating the user-generated content with an application template;
instructions to receive a second request from a second user of the social network service to access the social application;
instructions to respond to the second request with an instance of the social application that includes an advertisement; and
instructions to calculate an amount payable to the first user based on inclusion of the advertisement in the instance of the social application accessed by the second user.

15. A computer-implemented method to compensate a user of a social network service by placing advertisements on content generated by the user, the method comprising:
receiving a first request from a first user, wherein the first request is to create a social application for distribution to other users of a social network service, and wherein the first request includes text generated by the first user;
creating a social application by associating the user-generated text with an application template;
receiving a second request from a second user of the social network service to access the social application;
responding to the second request with an instance of the social application that includes an advertisement;
calculating an amount owed by an advertiser for the inclusion of the advertisement in the instance of the social application accessed by the second user; and
calculating an amount payable to the first user based on inclusion of the advertisement in the instance of the social application accessed by the second user.

16. The method of claim 15 wherein the advertisement that is included in the instance of the social application is dynamically selected based on demographics of the second user.

17. The method of claim 16 wherein the demographics are selected from the group consisting of: gender, age, geographic location, and social network connections.

18. The method of claim 15 wherein the advertisement that is included in the instance of the social application is selected based on the occurrence of keywords in the user-generated text of the social application.

19. The method of claim 15 further comprising: detecting selection of the advertisement by the second user.

20. The method of claim 19 further comprising: increasing the calculated amount payable to the first user in response to the detected selection of the advertisement.
